(19) United States
(12) Patent Application Publication
(10) Pub. No.: US 2014/0183934 A1
(43) Pub. Date: Jul. 3, 2014

(54) BRAKE SYSTEM

(71) Applicant: AISAN KOGYO KABUSHIKI KAISHA, Obu-shi (JP)

(72) Inventors: Shota YAMANAKA, Hekinan-shi (JP); Mamoru YOSHIOKA, Nagoya-shi (JP); Katsuhiko MAKINO, Chita-gun (JP)

(73) Assignee: AISAN KOGYO KABUSHIKI KAISHA, Obu-shi (JP)

(21) Appl. No.: 14/139,347

(22) Filed: Dec. 23, 2013

(30) Foreign Application Priority Data
Dec. 27, 2012 (JP) 2012-285731

(51) Int. Cl. B60T 13/52

(52) U.S. Cl. CPC B60T 13/52
USPC 303/12

(57) ABSTRACT

A brake system includes: a first passage connected to a negative pressure chamber of a brake booster; a second passage branching from the first passage; an electric vacuum pump in the second passage; a first check valve for preventing inflow of a fluid from the intake system to the negative pressure chamber through the second passage; and a second check valve for preventing inflow of a fluid from the intake system to the negative pressure chamber through the first passage and inflow of a fluid from the intake system and a discharge outlet of a pump part to a suction inlet in the pump through the first passage, wherein a filter is provided between a discharge outlet of the pump and the intake system.

### CROSS-REFERENCE TO RELATED APPLICATIONS

This application is based upon and claims the benefit of priority from the prior Japanese Patent Application No. 2012-285731, filed Dec. 27, 2012, the entire contents of which are incorporated herein by reference.

### BACKGROUND OF THE INVENTION

1. Field of the Invention

The present invention relates to a brake system including an electric vacuum pump for supplying negative pressure to a negative pressure chamber of a brake booster of a vehicle such as a car.

2. Related Art

A brake device for car is provided with a brake booster for amplifying a braking force by utilizing negative pressure in an intake pipe (“intake-pipe negative pressure”) of an engine. In recent years, pumping loss is reduced in response to demands for low-fuel consumption and thus the negative pressure in the intake pipe tends to decrease. Furthermore, for a hybrid vehicle, an electric vehicle, or a vehicle with an idling stop function, there is a case where the intake-pipe negative pressure of an engine could not be obtained.

Accordingly, the negative pressure to be supplied to a brake booster is generated by use of an electric vacuum pump. In a vehicle mounting a diesel engine that generates no intake-pipe negative pressure, negative pressure is also generated by use of an electric vacuum pump.

One example of such a brake system is disclosed in, for example, Patent Document 1. In this brake system, a negative pressure chamber of a negative pressure type booster is connected to a negative pressure output port provided in an intake system downstream of a throttle valve of an engine through a negative pressure passage. In this negative pressure passage, a check valve is located to inhibit back transfer of the negative pressure from the negative pressure chamber to the negative pressure output port. A bypass passage detouring around this check valve is connected to the negative pressure passage and a vacuum pump is placed in the bypass passage to reduce the pressure in a downstream side in the negative pressure passage via the bypass passage.

### RELATED ART DOCUMENTS

### Patent Documents

Patent Document 1: JP 57 (1982)-164854A

### SUMMARY OF INVENTION

### Problems to be Solved by the Invention

However, in the brake system disclosed in Patent Document 1, foreign matters coming from the vacuum pump, e.g., abrasion powder of vanes, fragments of the pump in case it is broken, etc., may flow in the intake system, resulting in adverse influence on the engine.

Furthermore, the brake system is desired to minimize operation sounds of the vacuum pump.

The present invention has been made to solve the above problems and has a purpose to provide a brake system capable of preventing inflow of foreign matters from a vacuum pump to an intake system and also reducing operation sounds of the pump.

### Means of Solving the Problems

To achieve the above purpose, one aspect of the invention provides a brake system including: a first passage connected to a negative pressure chamber of a brake booster, the first passage being to be connected to an intake system of an engine; a second passage branching from the first passage; an electric vacuum pump provided in the second passage; a first check valve for preventing inflow of a fluid from a side of the intake system to a side of the negative pressure chamber through the second passage; and a second check valve for preventing inflow of a fluid from the side of the intake system to the side of the negative pressure chamber through the first passage and inflow of a fluid from the side of the intake system and a side of a discharge outlet of a pump part to a side of a suction inlet in the electric vacuum pump through the first passage, wherein a filter is provided between a discharge outlet of the electric vacuum pump and the intake system.

### Effects of the Invention

According to a brake system of the present invention, as mentioned above, it is possible to prevent inflow of foreign matters from an electric vacuum pump to an intake system and also reduce operation sounds of the pump to a minimum.

### BRIEF DESCRIPTION OF THE DRAWINGS

FIG. 1 is a schematic configuration view of a brake system in a first embodiment;

FIG. 2 is a block diagram showing a control system of the brake system in the first embodiment;

FIG. 3 is a schematic enlarged cross sectional view of a second passage around a filter;

FIG. 4 is a schematic view showing a first modified example of the filter;

FIG. 5 is a schematic view showing a second modified example of the filter;

FIG. 6 is a top view of an electric vacuum pump;

FIG. 7 is a cross sectional view taken along a line A-A in FIG. 6;

FIG. 8 is a schematic configuration view of a brake system in a second embodiment;

FIG. 9 is a cross sectional view of an electric vacuum pump in the second embodiment;

FIG. 10 is a cross sectional view showing a first modified example of the electric vacuum pump in the second embodiment; and

FIG. 11 is a cross sectional view showing a second modified example of the electric vacuum pump in the second embodiment.

### DESCRIPTION OF EMBODIMENTS

A detailed description of embodiments of a brake system embodying the present invention will now be given referring to the accompanying drawings.

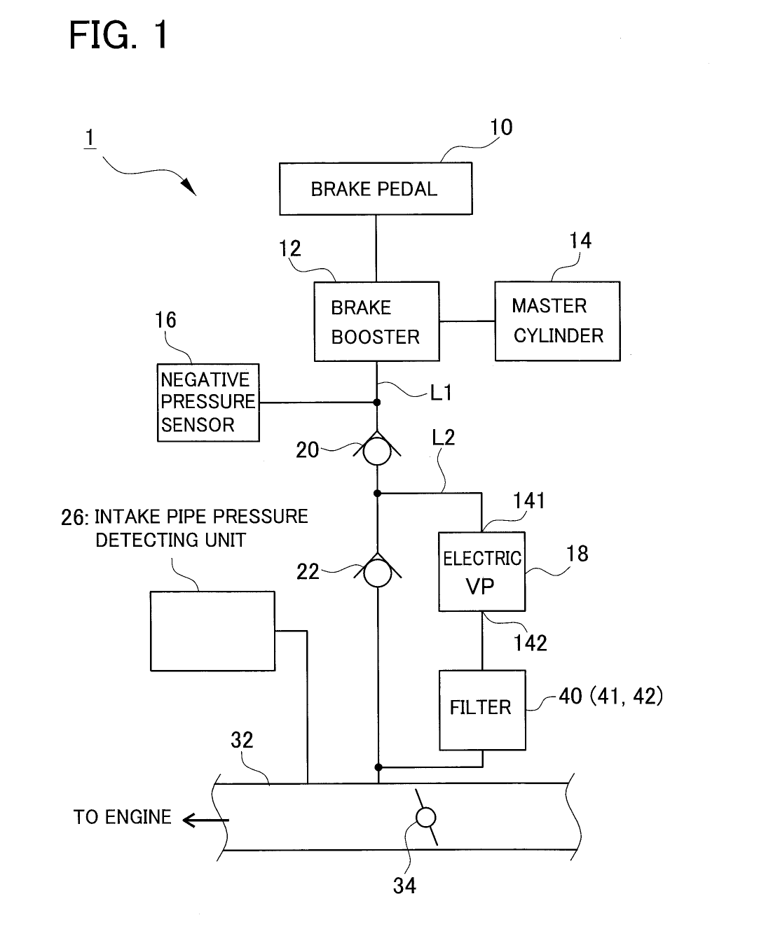

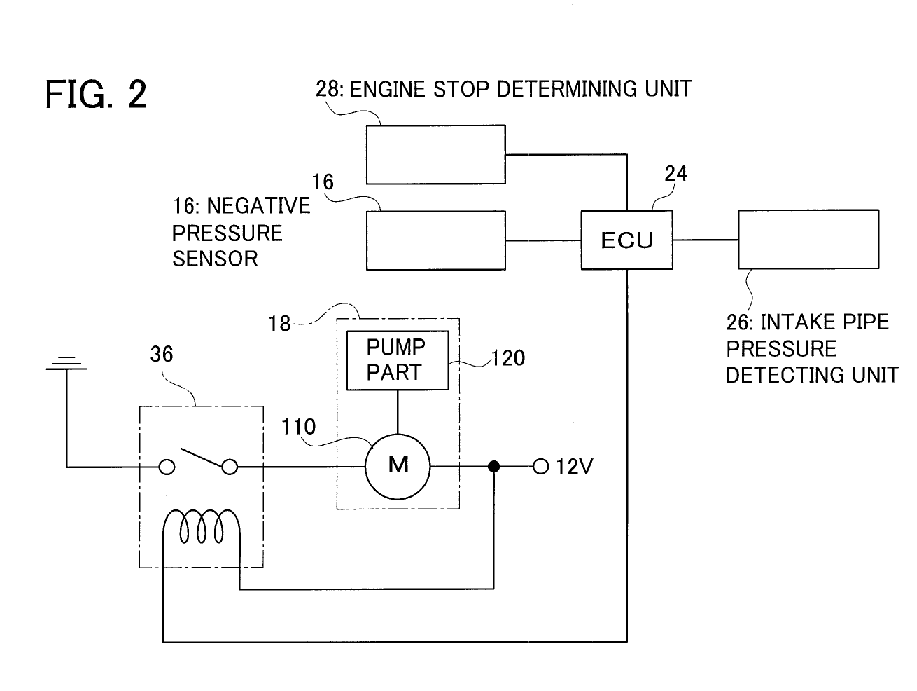

A first embodiment will be first explained. Thus, a brake system in the first embodiment is explained referring to FIGS. 1 and 2. FIG. 1 is a schematic configuration view of the brake system in the present embodiment. FIG. 2 is a block diagram showing a control system of the brake system in the present embodiment.

A brake system 1 in the present embodiment includes, as shown in FIGS. 1 and 2, a brake pedal 10, a brake booster 12, a master cylinder 14, a negative pressure sensor 16, an electric vacuum pump 18 (labeled “Electric VP” in the figure), a first check valve 20, a second check valve 22, an ECU 24, an intake pipe pressure detection unit 26, an engine stop determination unit 28, a filter 40, and others.

The brake booster 12 is provided between the brake pedal 10 and the master cylinder 14 as shown in FIG. 1. This brake booster 12 generates an assist force at a predetermined boosting ratio to a tread force on the brake pedal 10.

The brake booster 12 is internally partitioned by a diaphragm (not illustrated) into a negative pressure chamber (not shown) close to the master cylinder 14 and a transformer chamber (not shown) allowing introduction of atmospheric air. The negative pressure chamber of the brake booster 12 is connected to an intake pipe 32 of an engine through a first passage L1. Specifically, the first passage L1 is connected to the negative pressure chamber of the brake booster 12 and the intake pipe 32. Accordingly, the negative pressure chamber of the brake booster 12 is supplied with negative pressure generated in the intake pipe 32 through the first passage L1 according to an opening degree of a throttle valve 34 during driving of the engine.

The master cylinder 14 increases oil pressure of a brake main body (not shown) by operation of the brake booster 12, thereby generating a braking force in the brake main body. The negative pressure sensor 16 detects the negative pressure in the negative pressure chamber of the brake booster 12.

The electric vacuum pump 18 is connected to a second passage L2 as shown in FIG. 1. Specifically, a suction port 141 of the electric vacuum pump 18 is connected to the negative pressure chamber of the brake booster 12 through the second passage L2 and the first passage L1. It is to be noted that a discharge port 142 of the electric vacuum pump 18 is connected to the intake pipe 32 upstream of the throttle valve 34 and is open to the atmosphere. Herein, the second passage L2 is a pathway for branching from the first passage L1 at a position on the first passage L1 between the first check valve 20 and the second check valve 22.

The electric vacuum pump 18 is further connected to the ECU 24 through a motor part 110 (electric motor 112) and a relay 36 as shown in FIG. 2. Driving of the electric vacuum pump 18 is controlled by ON/OFF operation of the relay 36 by the ECU 24.

The first check valve 20 is provided in the first passage L1 at a position between a branch point to the second passage L2 and the brake booster 12 as shown in FIG. 1. The second check valve 22 is provided in the first passage L1 at a position closer to the intake pipe 32 than the first check valve 20 and between the branch point to the second passage L2 and the intake pipe 32. These first check valve 20 and second check valve 22 are each configured to open only when negative pressure on the side of the intake pipe 32 is higher than the negative pressure on the side of the negative pressure chamber of the brake booster 12 and to permit a fluid to flow only from the negative pressure chamber of the brake booster 12 to the intake pipe 32. In this manner, the brake system 1 can encapsulate negative pressure in the negative pressure chamber of the brake booster 12 by the first check valve 20 and the second check valve 22.

The ECU 24 consists of for example a microcomputer and includes a ROM that stores control programs, a rewritable RAM that stores calculation results and others, a timer, a counter, an input interface, and an output interface. To this ECU 24, as shown in FIG. 2, there are connected the negative pressure sensor 16, the electric vacuum pump 18, the intake pipe pressure detection unit 26, the engine stop determination unit 28, the relay 36, and others.

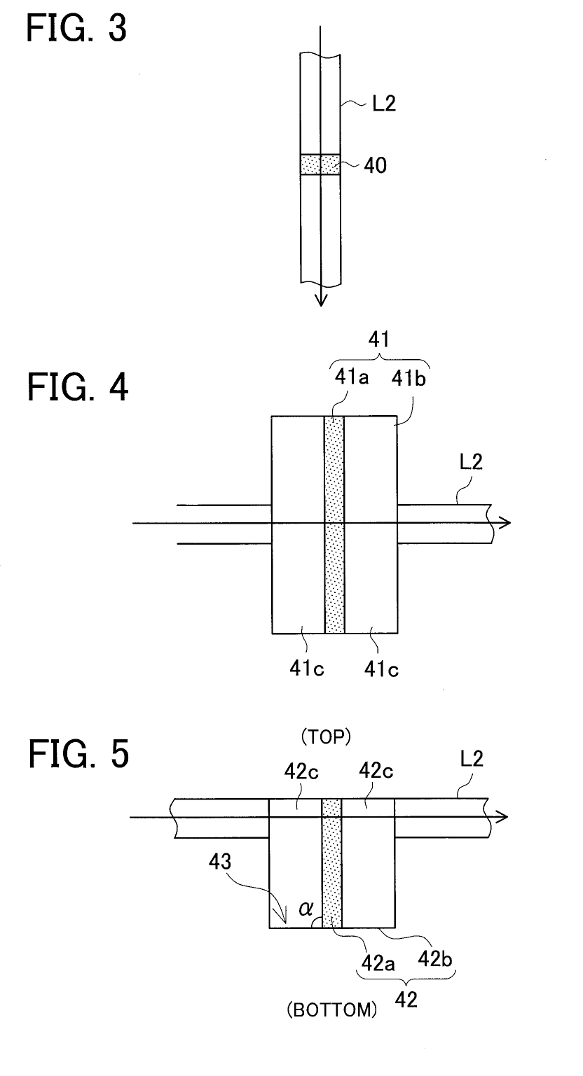

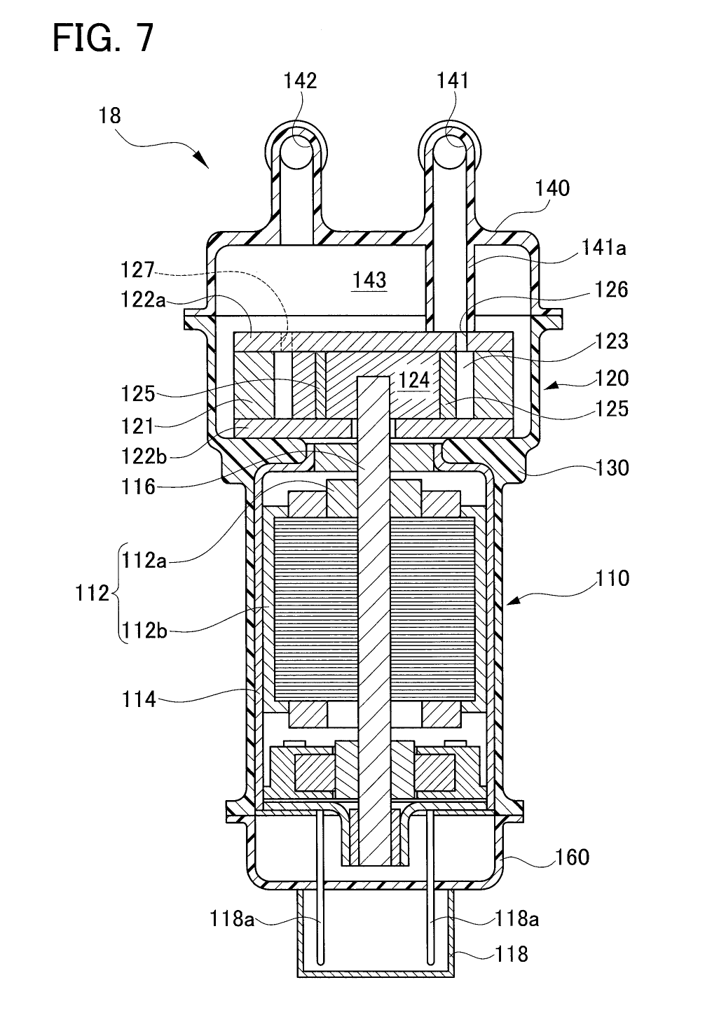

The filter 40 is provided in the second passage L2 at a position between the electric vacuum pump 18 and a connection point to the first passage L1, that is, at a position between a discharge outlet 127 (see FIG. 7) of a pump part 120 of the electric vacuum pump 18 and the intake pipe 32. The filter 40 is made of a porous material and placed in the second passage L2 as shown in FIG. 3. This filter 40 serves to collect foreign matters coming from the electric vacuum pump 18, e.g., friction powder of vanes, fragments of the pump in case it is broken, and others. An arrow in FIG. 3 represents a flowing direction of a fluid.

The filter 40 also serves to absorb or reduce the operation sounds of the electric vacuum pump 18. This sound-absorbing function is brought about in such a manner that, when the exhaust air from the electric vacuum pump 18 passes through the filter 40, this air expends energy (converts to heat energy) due to friction, a flowing direction of the exhaust air is changed, and pulsations are reduced owing to the elastic effect.

Herein, modified examples of the filter are explained referring to FIGS. 4 and 5. FIG. 4 is a schematic view showing a first modified example of the filter. FIG. 5 is a schematic view showing a second modified example of the filter. Arrows in FIGS. 4 and 5 represent a flowing direction of a fluid.

The first modified example is first explained. A filter 41 in the first modified example includes a filter body 41a and a filter case 41b as shown in FIG. 4. The filter case 41b holds and fixes therein the filter body 41a so that air layers (spaces) 41c are generated on both sides of the filter body 41a. The filter surface area of the filter body 41a is set to be larger than a cross sectional area of the second passage L2.

This can enhance the sound-absorbing effect when the fluid passes through the filter 41. Furthermore, a fluid passage is widened at a position in which the filter 41 is placed, so that exhaust air is repeatedly exposed to loads. This can further enhance the sound-absorbing effect to absorb the pump operation sounds. Since the filter surface area of the filter body 41a is larger than that in the first embodiment, the filter 41 can provide higher capacity of collecting foreign matters.

Furthermore, the air layers 41c formed on both sides of the filter body 41a act as a silencer and thus can repeatedly apply loads to the exhaust air. Accordingly, the pump operation sounds can be further reduced.

The second modified example is explained below. A filter 42 in the second modified example includes a filter body 42a and a filter case 42b as shown in FIG. 5. The filter case 42b holds and fixes therein the filter body 42a so that air layers (spaces) 42c are generated on both sides of the filter body 42a. In the filter 42, the filter body 42a is placed so that an angle α between a collecting surface and a horizontal direction (a lateral direction in FIG. 5) while the brake system 1 is mounted in a vehicle is 90° or less (FIG. 5 illustrates the case of α=90° as an example), and a trapping part 43 is provided on a bottom side (a lower side in FIG. 5) to trap foreign matters peeled from the filter body 42a. Furthermore, as in the first modified example, the filter surface area of the filter body 42a is set to be larger than the cross sectional area of the second passage L2.

Accordingly, in addition to the effects obtainable from the first modified example, the trapping part can store the foreign matters collected by the filter. This can restrain deterioration in the capacity of collecting foreign matters.

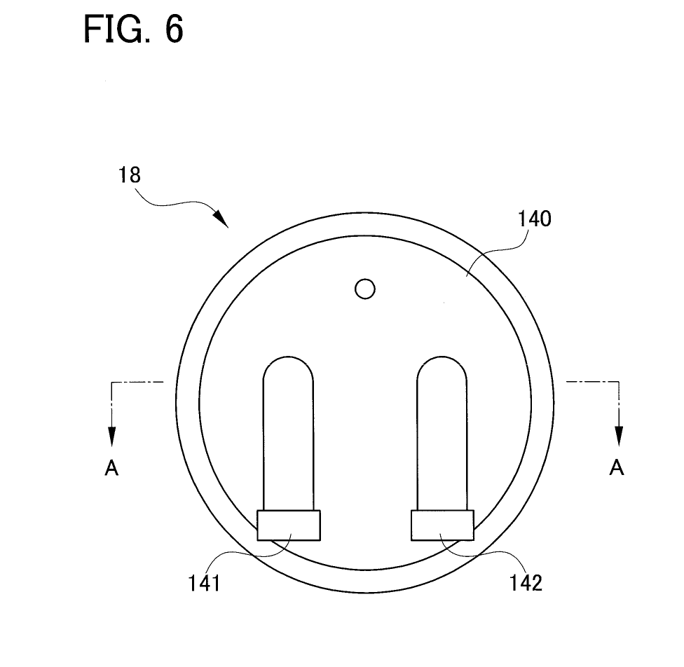

Next, the electric vacuum pump 18 will be explained referring to FIGS. 6 and 7. FIG. 6 is a top view of the electric vacuum pump in the present embodiment. FIG. 7 is a cross sectional view taken along a line A-A in FIG. 6.

The electric vacuum pump 18 has a cylindrical shape as shown in FIGS. 6 and 7 and is provided with the suction port 141 and the discharge port 142 at an upper end and a connector 118 at a lower end. This electric vacuum pump 18 includes the motor part 110, the pump part 120, a resin case 130, a resin upper cover 140, and a resin lower cover 160. Further, as shown in FIG. 7, the motor part 110 and the pump part 120 are housed in the case 130. The case 130 containing the motor part 110 and the pump part 120 is closed by the upper cover 140 and the lower cover 160.

The motor part 110 includes the electric motor 112, a metal motor case 114, a rotary shaft 116, and the connector 118. The electric motor 112 is housed in the motor case 114 and includes a rotor 112a and a stator 112b. The stator 112b is fixed to the motor case 114 so that the rotor 112a is rotatably placed inside the stator 112b with a clearance therefrom.

The rotary shaft 116 is attached to this rotor 112a. The connector 118 including terminals 118a for supplying electric power to the electric motor 112 is provided on the lower cover 160.

Accordingly, in the motor part 110, the electric motor 112 is driven by an external power supply connected through the connector 118 to drive the rotary shaft 116 to rotate. The rotary shaft 116 is rotatably supported by a bearing fixed to the motor case 114.

The pump part 120 is constituted of a vane-type vacuum pump and is placed above the motor part 110 in the case 130. Herein, the vane-type vacuum pump is configured such that a rotor having a circular columnar shape placed in an eccentric state in a pump chamber is formed with grooves, in which a plurality of vanes are inserted to be movable in a rotor radial direction. When the rotor rotates, the vanes are caused to protrude from the grooves by centrifugal force and slide in contact with the inner peripheral surface of the pump chamber, thereby maintaining hermetical sealing between adjacent small chambers of the pump chamber. In association therewith, the volume of each closed space or small chamber partitioned by the vanes is increased or decreased, thereby causing suction, compression, and discharge of air, so that negative pressure is generated in the pump chamber.

To be concrete, the pump part 120 is provided with a housing 121 having an inner peripheral surface of a nearly cylindrical shape. The inner peripheral surface of a nearly cylindrical shape represents that the cross section of the housing is defined in a circular shape surrounded by a curved line without being limited to a perfect circular or elliptic shape. Both ends of the housing 121 are closed by circular cover members 122a and 122b, so that a pump chamber 123 is formed by the inner peripheral surface of the housing 121 and the cover members 122a and 122b. The housing 121 is fixed to the case 130.

In the pump chamber 123, a circular columnar rotor 124 is housed to be rotatable about the axis eccentric to the center axis of the pump chamber 123. This rotor 124 is coupled to the rotary shaft 116 of the electric motor 112. Accordingly, the rotor 124 is rotated in sync with rotary driving of the electric motor 112 via the rotary shaft 116.

The rotor 124 has a plurality of vane grooves formed radially extending from the axis in a radial direction. In the vane groove, vanes 125 each formed in a flat plate shape are slidably engaged to be movable in and out in the radial direction of the circular columnar rotor 124. Those vanes 125 are arranged radially and spaced circumferentially at equal intervals. A radially outer end of each vane 125 slides in contact with the inner peripheral surface of the housing 121 by centrifugal force imparted to the vanes 125 during rotation of the rotor 124. Upper and lower end faces of the vanes 125 are in contact with the cover members 122a and 122b respectively. Thus, the vanes 125 partition the pump chamber 123 into a plurality of small chambers or spaces.

The pump chamber 123 communicates with the outside through a suction inlet 126 and the discharge outlet 127. The suction inlet 126 is provided in the cover member 122a and communicated with the pump chamber 123. The suction inlet 126 is hermetically connected to the inlet pipe 141a continuous with the suction port 141 to suck air from pump outside (the outside of the electric vacuum pump 18) into the pump chamber 123. Similarly, the discharge outlet 127 is also provided in the cover member 122a and communicated with the pump chamber 123. Exhaust air ejected from the discharge outlet 127 is discharged to the pump outside through the discharge port 142.

The upper cover 140 is a resin member closing an upper open end of the case 130 that houses the motor part 110 and the pump part 120. Specifically, the upper cover 140 closes the case 130 from the pump part side (from above in FIG. 7).

This upper cover 140 is provided with the suction port 141 to suck air in the pump part 120 from the pump outside, the inlet pipe 141a connected to the suction port 141, a silencer part 143 including a space or cavity communicating with the discharge outlet 127 of the pump part 120, and the discharge port 142 to discharge exhaust air discharged or ejected from the pump part 120 to the pump outside. Those suction port 141, inlet pipe 141a, and discharge port 142 are made together with the upper cover 140 by integral molding.

The silencer part 143 is formed by the internal space of the upper cover 140. Thus, exhaust air discharged or ejected from the discharge outlet 127 of the pump part 120 passes through the silencer part 143 and then is discharged to the pump outside through the discharge port 142. Consequently, the exhaust air can be repeatedly exposed to loads, so that pump operation sound or noise can be reduced to a minimum. In this manner, the electric vacuum pump 18 can be effectively provided with the sound-reducing measure with a very simple structure.

The lower cover 160 is a resin member closing a lower open end of the case 130 that houses the motor part 110 and the pump part 120. The lower cover 160 closes the case 130 from the motor part side (from below in FIG. 7). This lower cover 160 is provided, by integral molding, with the connector 118 including the terminals 118a extending from the motor part 110.

In the electric vacuum pump 18 configured as above, when the electric motor 112 is driven to rotate upon receipt of power from an external source, the rotor 124 is rotated in synchronization therewith. Then, the vanes 125 slide along the vane grooves by centrifugal force, causing the end faces of the vanes 125 to contact with the inner peripheral surface of the housing 121. While keeping such a contact state, the vanes 125 are rotated along the inner peripheral surface of the housing 121. This rotation of the rotor 124 causes the volume of each small chamber of the pump chamber 123 to expand or contract, thereby sucking air into the pump chamber 123 through the suction inlet 126 and ejecting air from the pump chamber 123 through the discharge outlet 127. This operation generates negative pressure in the pump chamber 123.

Specifically, in the brake system 1, when the relay 36 is turned on based on a drive start signal from the ECU 24, the electric vacuum pump 18 starts operating, thereby supplying negative pressure to the negative pressure chamber of the brake booster 12 through the suction port 141, the second passage L2 and the first passage L1. Furthermore, when the relay 36 is turned off based on a drive stop signal from the ECU 24, the electric vacuum pump 18 stops operating, thereby stopping supplying negative pressure to the negative pressure chamber of the brake booster 12 through the suction port 141, the second passage L2 and the first passage L1.

In the brake system 1, in a case where the engine is running and negative pressure is generated in the intake pipe, the negative pressure in the intake pipe 32 is supplied to the negative pressure chamber of the brake booster 12 through the first passage L1 to regulate the negative pressure in the negative pressure chamber of the brake booster 12.

In a case where the engine is stopped or in a case where the ECU 24 determines that the negative pressure is insufficient, the ECU 24 turns on the relay 36, thereby driving the electric vacuum pump 18 to supply the negative pressure to the negative pressure chamber of the brake booster 12 through the second passage L2 and the first passage L1. Thus, the negative pressure in the negative pressure chamber of the brake booster 12 can be regulated. In this state, the discharged air from the electric vacuum pump 18 is allowed to flow in the intake pipe 32 through the filter 40. Thus, in case foreign matters (e.g., friction powder of vanes or fragments of the pump in case it is broken) are generated in the electric vacuum pump 18, it is surely possible to prevent those foreign matters from flowing in the engine. Further, the sound-absorbing effects can also be expected by expenditure of energy of the fluid by friction with the filter 40 and change of the flowing direction of the fluid in passing though the filter 40. This can reduce the operation sounds of the electric vacuum pump 18 to a minimum.

According to the brake system 1 in the first embodiment explained in detail above, in which the filter 40 is provided between the electric vacuum pump 18 and the intake pipe 32, it is possible to prevent the foreign matters generated in the electric vacuum pump 18 (e.g., friction powder of vanes and fragments of the pump in case it is broken) from flowing in the engine. Further, the sound-absorbing effect brought out when the fluid passes through the filter 40 can also reduce the operation sounds of the electric vacuum pump 18 to a minimum.

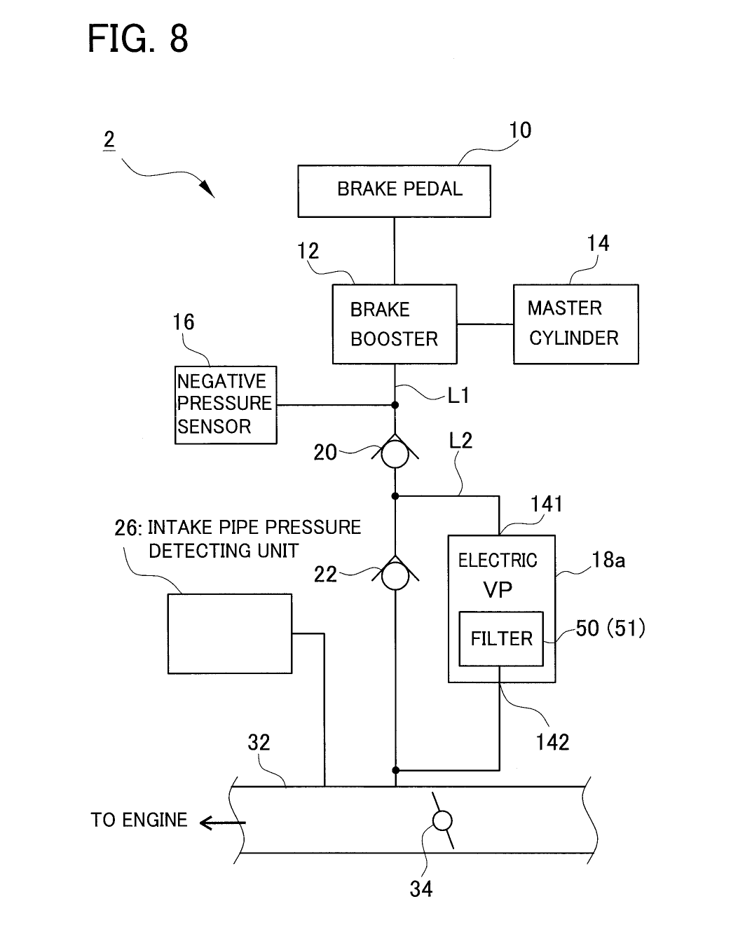

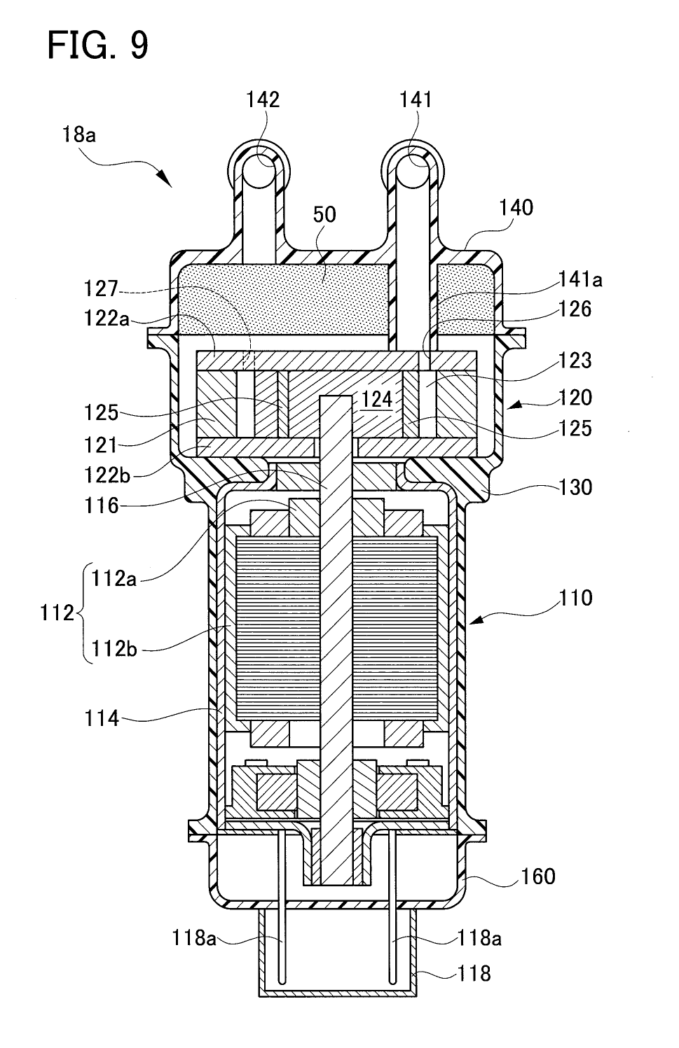

A second embodiment will be explained below. A brake system in the second embodiment is thus explained referring to FIGS. 8 and 9. FIG. 8 is a schematic configuration view of a brake system in the second embodiment. FIG. 9 is a cross sectional view of an electric vacuum pump in the second embodiment.

A brake system in the second embodiment is identical in basic configuration to that in the first embodiment but is different therefrom in that a filter is placed in an electric vacuum pump. Therefore, the following explanation is given with the same reference signs for the same or similar parts as those in the first embodiment, and their details are appropriately omitted.

As shown in FIG. 8, the brake system 2 includes the brake pedal 10, the brake booster 12, and the master cylinder 14, the negative pressure sensor 16, an electric vacuum pump 18a, the first check valve 20, the second check valve 22, the ECU 24, the intake pipe pressure detection unit 26, the engine stop determination unit 28, a filter 50, and others. The filter 50 is placed in the electric vacuum pump 18a, not in the second passage.

The electric vacuum pump 18a is configured as shown in FIG. 9 such that the filter 50 is placed in a position corresponding to the silencer part 143 of the electric vacuum pump 18 in the first embodiment. Specifically, the filter 50 is filled in the space defined between the discharge outlet 127 and the discharge port 142. The filter 50 is made of a porous material as with the filter 40.

Since the filter 50 is placed in the electric vacuum pump 18a as above, size reduction and cost reduction of a brake system can be achieved, and also mountability on a vehicle can be enhanced. Furthermore, since the filter 50 can be placed near the pump part 120, the sound-absorbing effect can be further enhanced.

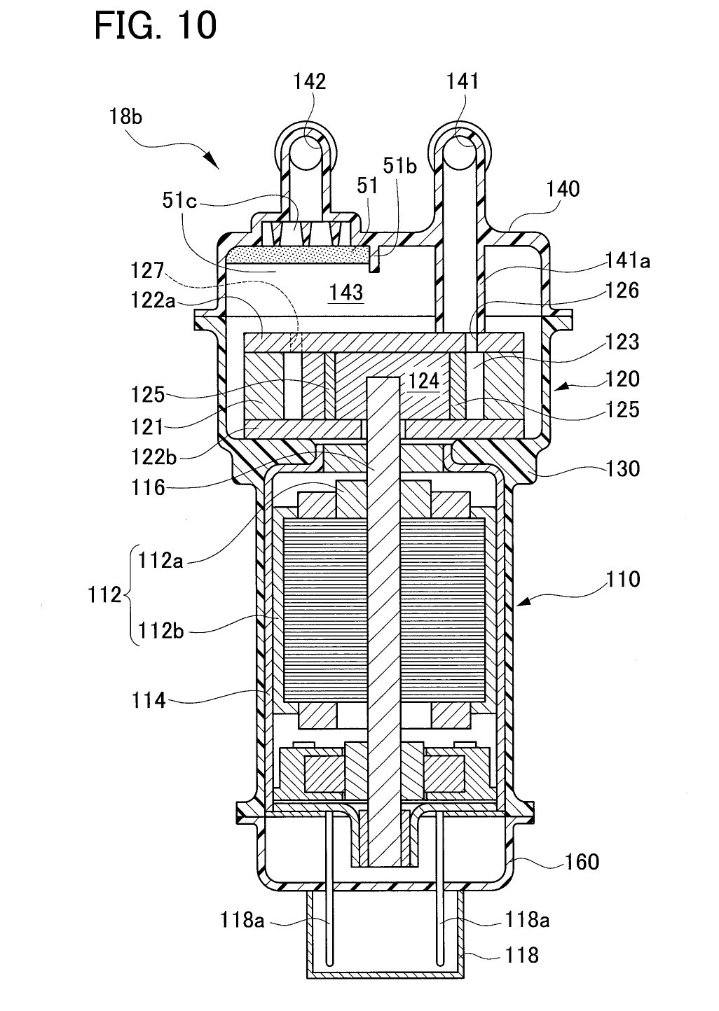

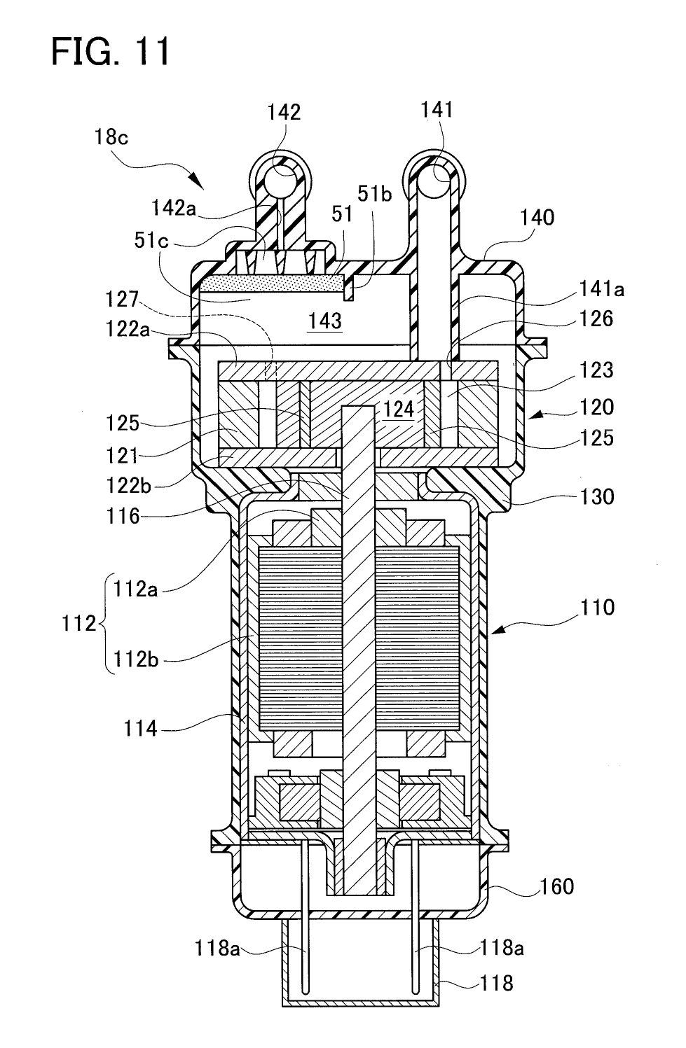

Herein, modified examples of the electric vacuum pump having a built-in filter will be explained referring to FIGS. 10 and 11. FIG. 10 is a view showing a first modified example of the electric vacuum pump having a built-in filter. FIG. 11 is a view showing a second modified example of the electric vacuum pump having a built-in filter.

The first modified example is first explained. An electric vacuum pump 18b in the first modified example is configured such that a filter 51 is placed in a part of the silencer 143 as shown in FIG. 10. To be concrete, the filter 51 is attached to a filter attachment part 51b formed in the upper cover 140. Air layers (spaces) 51c are formed on both sides of the filter 51.

Accordingly, the first modified example can provide the following advantages in addition to the aforementioned effects. Since the air layers 51c act as a silencer, the exhaust air can be repeatedly exposed to loads and thus the pump operation sounds can be further reduced.

The second modified example is explained. An electric vacuum pump 18c in the second modified example is configured such that the filter 51 is placed in a part of the silencer part 143 as in the first modified example as shown in FIG. 11. To be concrete, the filter 51 is attached to the filter attachment part 51b formed in the upper cover 140. Further, the air layers (spaces) 51c are formed on both sides of the filter 51.

In the electric vacuum pump 18c, furthermore, a throat part 142a is formed in the discharge port 142. Specifically, the inner diameter (a portion having a smallest port diameter) of the discharge port 142 is set to smaller than the inner diameter of the second passage L2. The shape of the throat part 142a is not particularly limited and may have a narrow throat extending over the entire length of the throat part 142a as shown in FIG. 11 or have a constriction in a part of the discharge port.

Accordingly, the second modified example can provide the following advantages in addition to the effects obtained in the first modified example. Specifically, the exhaust air is exposed to loads when the exhaust air passes through the discharge port 142, thereby enabling further reduction of the pump operation sounds to a minimum.

According to the brake system 2 in the second embodiment as explained in detail above, in which the filter 50 (51) is placed in the electric vacuum pump 18a (18b, 18c), in addition to the effects obtained in the first embodiment, size reduction and cost reduction of the brake system can be achieved and also mountability on a vehicle can be enhanced. Since the filter 50 (51) can be placed near the pump part 120, the sound-absorbing effect can be further enhanced.

The aforementioned embodiments are mere examples and do not limit the invention. Of course, the present invention may be embodied in other specific forms without departing from the essential characteristics thereof.

1. A brake system including:
a first passage connected to a negative pressure chamber of a brake booster, the first passage being to be connected to an intake system of an engine;
a second passage branching from the first passage;
an electric vacuum pump provided in the second passage;
a first check valve for preventing inflow of a fluid from a side of the intake system to a side of the negative pressure chamber through the second passage; and
a second check valve for preventing inflow of a fluid from the side of the intake system to the side of the negative pressure chamber through the first passage and inflow of a fluid from the side of the intake system and a side of a discharge outlet of a pump part to a side of a suction inlet in the electric vacuum pump through the first passage,
wherein a filter is provided between a discharge outlet of the electric vacuum pump and the intake system.

2. The brake system according to claim 1, wherein the filter is placed in the electric vacuum pump.

3. The brake system according to claim 1, wherein the filter is placed between the discharge outlet of the pump part and a discharge port of the electric vacuum pump.

4. The brake system according to claim 3,
wherein the filter is made of a porous material and filled in a space formed between the discharge outlet of the pump part and the discharge port of the electric vacuum pump.

5. The brake system according to claim 3, wherein an air layer is formed at least one of between the discharge outlet of the pump part and the filter and between the filter and the discharge port of the electric vacuum pump.

6. The brake system according to claim 3,
wherein the discharge port of the electric vacuum pump has an inner diameter smaller than an inner diameter of the second passage.

7. The brake system according to claim 1, wherein the filter is provided in a predetermined position in the second passage.

8. The brake system according to claim 7, wherein the filter has a filter surface area larger than a passage cross sectional area of the second passage.

9. The brake system according to claim 1, wherein the filter is placed so that an angle formed between a collecting surface of the filter and a horizontal direction while the brake system is mounted on a vehicle is 90° or less, and a trapping part is provided on a bottom side to trap foreign matters peeled from the filter.
